(19) United States
(12) Patent Application Publication
(10) Pub. No.: US 2011/0047146 A1
(43) Pub. Date: Feb. 24, 2011

(54) Systems, Methods, and Computer Program Product for Mobile Service Data Browser

(76) Inventor: Richard Craig Scott, Raleigh, NC (US)

Correspondence Address: PRIEST & GOLDSTEIN PLLC, 5015 SOUTHPARK DRIVE, SUITE 230, DURHAM, NC, 27713-7736, US

(21) Appl. No.: 12/544,270

(22) Filed: Aug. 20, 2009

(51) Int. Cl. G06F 17/30

(52) U.S. Cl. 707/722; 707/E17.109

(57) ABSTRACT

Methods, apparatus, and computer-readable media are described for accessing information related to a request in addition to the requested information. A query is submitted from a user device that requests specific information from a database. The query is executed to access a database snippet which includes the specific information and additional information related to the query. A hierarchical data object is formed from the accessed database snippet. Metadata tags are added to create a tagged hierarchical data object and the tagged hierarchical data object is sent to the user device, wherein the hierarchical data object may be accessed and displayed independent of the display size of the user device, and without a requirement to develop display forms needed with conventional solutions.

### FIELD OF THE INVENTION

The present invention relates generally to mobile device application systems, methods, and computer program products, and more particularly to advantageous techniques and models for tools and data base browser support for mobile service applications.

### BACKGROUND OF INVENTION

Portable products such as cell phones, personal data assistants (PDAs) and the like, utilize a processing system that executes programs to provide communications and multimedia applications. In the past, such processing systems have been relatively low in processing capability limiting the communication and multimedia applications that could be run on the portable device while still having reasonable battery life. As technology continues to improve, the processing power and memory capacity of portable devices have increased dramatically. This increased capability would generally allow unique applications to be developed that provide desktop computing experience in a portable device. However, the portable devices are still limited by restricted input and output means, such as a small keypad for text entry and limited display size, and may experience intermittent or lack of wireless service. These limitations, even with the advent of smart phones with their further improved processing capabilities, larger displays, and wireless connectivity, have not resolved the many problems faced with respect to the general use of the portable devices in applications requiring access to a database.

### SUMMARY OF INVENTION

Among its several aspects, the present invention recognizes that there is a need for new, improved, and cost effective methods for bringing data from a corporate database to a remote device with a minimum amount of setup and startup efforts and without the need for custom software development. To such ends, an embodiment of the invention includes a method for accessing information related to a request in addition to the requested information. A query request is submitted from a mobile user device that requests specific information from a database. The query request is executed to access a database snippet which includes the specific information and additional information related to the query request. A hierarchical data object is formed from the accessed database snippet. Display and control tags are added to create a tagged hierarchical data object and the tagged hierarchical data object is sent to the mobile user device, wherein the hierarchical data object may be accessed and displayed independently of the display size of the mobile user device.

Another embodiment of the invention includes a method for converting a database snippet into a hierarchical object structure having more information than requested by a user. Specific information and associated additional information related to steps a user takes to accomplish a particular activity are determined. One or more queries are submitted to access the specific information and the associated additional information to receive response result sets corresponding to the one or more queries, wherein the response result sets represent a database snippet. Metadata tags are added to the one or more queries that identify a hierarchical structure of the specific information and the associated additional information for display on a user device. Corresponding response result sets are tagged, wherein the database snippet is converted to a hierarchical object structure from the tagged corresponding response result sets.

Another embodiment of the present invention addresses a computer readable medium storing a computer program which causes a computer system to perform a method for accessing information related to a request in addition to the requested information. A query request is submitted from a mobile user device that requests specific information from a database. The query request is executed to access a database snippet which includes the specific information and additional information related to the query request. A hierarchical data object is formed from the accessed database snippet. Display and control tags are added to create a tagged hierarchical data object and the tagged hierarchical data object is sent to the mobile user device, wherein the hierarchical data object may be accessed and displayed independently of the display size of the mobile user device.

Another embodiment of the present invention addresses a system for accessing information related to a request in addition to the requested information. The system includes a database, a wireless mobile user device, and a mobile access server. The wireless mobile user device submits a query that requests specific information from the database. The mobile access server is operative to execute the query to access a database snippet which includes the specific information and additional information related to the query, to form a hierarchical data object from the accessed database snippet, to add display tags to create a tagged hierarchical data object, and to send the tagged hierarchical data object to the wireless mobile user device, wherein the hierarchical data object may be accessed and displayed independently of the display size of the wireless mobile user device.

A more complete understanding of the present invention, as well as other features and advantages of the invention, will be apparent from the following detailed description and the accompanying drawings.

### BRIEF DESCRIPTION OF DRAWINGS

FIG. 1 illustrates an exemplary mobile database system in accordance with an embodiment of the present invention;

FIG. 2 illustrates an exemplary mobile database system in accordance with the present invention;

FIG. 3 illustrates a mobile organized setup, control, and configuration database of exemplary system configuration tables in accordance with the present invention;

FIG. 4 illustrates a query configuration process in accordance with the present invention;

FIG. 5A illustrates an exemplary mobile access authentication and startup process in accordance with the present invention;

FIG. 5B illustrates an exemplary mobile query process in accordance with the present invention;

FIG. 5C illustrates an exemplary mobile access receive and operate process in accordance with the present invention;

FIG. 6 illustrates an exemplary non-hierarchical query execution process in accordance with the present invention;

FIGS. 7A-7C illustrate an exemplary single hierarchical data object query execution process in accordance with the present invention;

FIG. 7D illustrates exemplary tagged structured query language (SQL) select entries for formatting query results in a hierarchical organization in accordance with the present invention;

FIGS. 8A-8C illustrate an exemplary multiple hierarchical data object query execution process in accordance with the present invention; and

FIG. 9 illustrates exemplary tagged SQL select entries for formatting multiple query result sets in a hierarchical organization in accordance with the present invention.

### DETAILED DESCRIPTION

The present invention will now be described more fully with reference to the accompanying drawings, in which several embodiments and various aspects of the invention are shown. This invention may, however, be embodied in various forms and should not be construed as being limited to the embodiments set forth herein. Rather, these embodiments are provided so that this disclosure will be thorough and complete, and will fully convey the scope of the invention to those skilled in the art.

It will be appreciated that the present disclosure may be embodied as methods, systems, or computer program products. Accordingly, the present inventive concepts disclosed herein may take the form of a hardware system environment, a software embodiment or an embodiment combining software and hardware aspects. Furthermore, the present inventive concepts disclosed herein may take the form of a computer program product on a computer usable storage medium having computer usable program code embodied in the medium. Any suitable computer readable medium may be utilized including hard disks, CD-ROMs, optical storage devices, flash memories, or magnetic storage devices.

Computer program code or software programs that are operated upon or for carrying out operations according to the teachings of the invention may be written in a high level programming language such as C, C++, JAVA®, Smalltalk, JavaScript®, Visual Basic®, TSQL, Per, .XML, HTML, NET™ Framework, Visual Studio® or in various other programming languages. Software programs may also be written directly in a native assembler language for a target processor. A native assembler program uses instruction mnemonic representations of machine level binary instructions. Program code or computer readable medium as used herein refers to code whose format is understandable by a processor. Software embodiments of the disclosure do not depend upon their implementation with a particular programming language.

The methods described in connection with the embodiments disclosed herein may be embodied directly in a software module executed by a processor. A software module may reside in RAM memory, flash memory, ROM memory, EPROM memory, EEPROM memory, registers, hard disk, a removable disk, a CD-ROM, or any other form of storage medium known in the art. A computer-readable storage medium may be coupled to the processor through local connections such that the processor can read information from, and write information to, the storage medium or through network connections such that the processor can download information from or upload information to the storage medium. In the alternative, the storage medium may be integral to the processor.

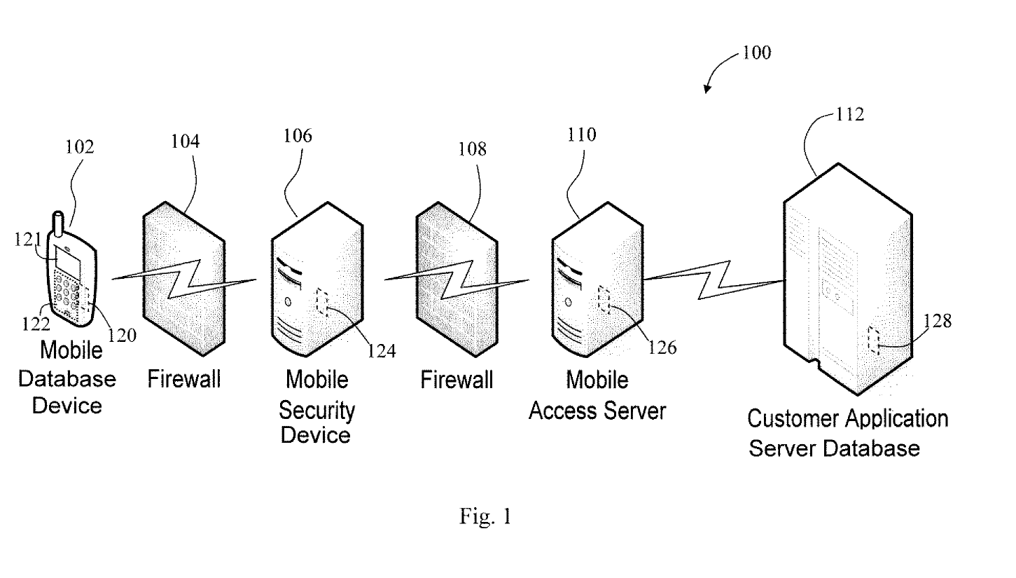

FIG. 1 illustrates an exemplary mobile database system 100 in accordance with an embodiment of the present invention. The mobile database system 100 may suitably include a plurality of user devices, such as a mobile database device 102 that comprises, for example, a processor complex 120 having internal storage for programs and data, a display 121, a keypad 122, and additional peripheral devices and their associated interfaces supporting printers, scanners, communications, displays, microphones, speakers, and the like. While the single mobile database device 102 is shown, a typical system will include as many such devices as needed. For example, a state inspection department with twenty inspectors might have one mobile database device per inspector, which may be all of the same type device or of varying types of devices, plus one or more backup devices or spares. At the start of a working period, one of the inspectors selects a query from the mobile database device to download a queue of today's work assignments, information about assignments, and a set of allowable information queries that may be submitted tailored for today's work assignments. During the day, the inspector may enter inspection results for each work assignment, and may also submit one of the allowable information queries for specific information which returns the specific information and additional information related to the query. For example, requesting information for a specific aspect of the present assignment returns additional information on past inspection results, previously issued warnings, and previously issued citations if any. Conventional solutions would require a custom application to be written or would require a user to submit multiple transactions to a database server and still not obtain results such as provided from this solution. In such conventional solutions custom display forms would generally be developed in order to show the data to the user, which is not necessary using the methods described herein.

The internal storage of device 102 may store programs, such as a mobile database thin client program in accordance with the present invention, or have access to such programs through electronic media that may be downloaded wirelessly or via a cabled connection from a server, accessed through a universal serial bus (USB) port from a flash memory, accessed from disk media of various types, and the like. A user may be, for example, a mobile sales person, such as a realtor, a field service person for a company, such as an electric company service person, and the like.

The mobile database device 102 is typically set up with the mobile database thin client program that can be controlled and configured remotely. The mobile database device 102 may be wirelessly connected through a first firewall 104 to a mobile security device 106. The mobile security device 106 comprises, for example, a processor complex 124 having internal program storage for a program or programs that enable Internet firewall security layers.

The mobile security device 106 is then further connected through a second firewall 108 to a mobile access server 110 which controls the functionality of the mobile database system 100. While the mobile database system 100 is shown with a specific security arrangement including firewall 104, mobile security device 106 and firewall 108, it will be appreciated that alternative arrangements for security may be used. For example, the mobile access server 110 may include a local firewall and security modules to meet the requirements of the mobile database system 100. The mobile access server 110 comprises, for example, a processor complex 126 having internal program storage for a program or programs that control the functionality of the mobile database system 100. The mobile access server 110 may also store a master copy of the mobile database thin client program and control distribution and licensing of the mobile database thin client program to various registered user mobile database devices.

The mobile access server 110 has access to one or more customer application server databases 112 which may be accessed for data to be used on the mobile database device 102 as described in more detail below. For example, the mobile access server 110 may support more than one customer each having one or more databases where information may be accessed. The customer application server databases 112 comprise a processor complex 128 having internal program storage for a program or programs that control accesses to various databases of the mobile database system 100.

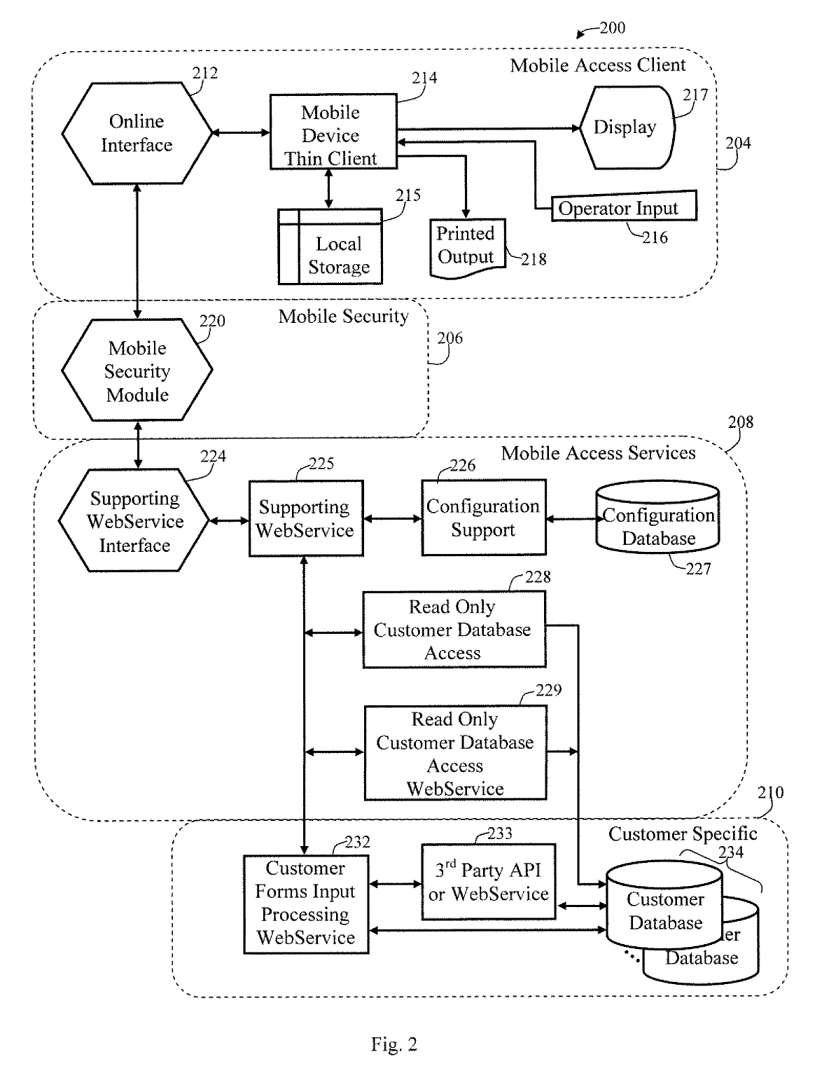

FIG. 2 illustrates an exemplary mobile database system 200 in accordance with a further aspect of the present invention. The mobile database system 200 comprises a mobile access client 204 installed, for example, on the mobile database device 102, a mobile security layer 206 installed, for example, on mobile security device 106, a mobile access services layer 208 installed, for example on mobile access server 110, and a customer specific layer 210 installed, for example, on the customer application server database 112. A software layer is considered herein as a program having a separate function that interacts with one or more other software layers.

The mobile access client 204 comprises an online interface for linking to the mobile access services layer 208 through the mobile security layer 206. The mobile device thin client 214 receives configuration information, mobile database device user menus, and service specific functionality configuration information from the mobile access services layer 208. For example, the configuration information for the local mobile database device may include host name and address, a user identification (ID), a password (PW), encryption settings, and peripheral device control, such as for use with a printer that may be attached to the mobile database device. The mobile device thin client 214 provides offline review and browsing of retrieved data and offline forms input capture, as well as real time data queries to the customer database 234. The data queries may include work queue listings, customer information, and other related information. The data queries may also include an input form or forms for subsequent entries as a means for notification of events, such as completion of requested work, and entry of new information, such as problems encountered, that are to be noted and entered at the mobile access services layer 208. The mobile device thin client 214 also enables real time data queries, configures data queries for daily update as required by a particular service, and may be configured for batch updates by request of a mobile database device user.

The mobile security module 220 when employed with a mobile database system, such as the mobile database system 100 of FIG. 1, may suitably include database access control and encryption utilized to validate a user or mobile database device using a network active directory of allowed users and allowed mobile database devices. The mobile security module 220 receives configuration settings from the mobile access services layer 208. The configuration settings include, for example, security settings, such as encryption settings, and location of an application's primary web service.

The mobile access services layer 208 comprises a supporting web service interface 224, a supporting web service module 225, a configuration support module 226, a configuration database 227, a read only customer database access module 228, and a read only customer database access web service module 229. The supporting web service interface 224 provides a communication interface for the mobile access services layer. The supporting web service module 225 provides the control logic and main functionality of the mobile access services layer. It listens to and responds to requests from the mobile access client. The configuration support module 226 provides configuration information from the configuration database when requested by the mobile access services layer. The configuration database 227 stores customer specific and mobile database device specific configuration information for setup and initialization of a distributed set of mobile database devices. The configuration database 227 may store information on how to retrieve that information from the customer database, along with related control and viewing control information to be sent to the mobile access client. The configuration database 227 may also store customer specific information on supported mobile users and specify usage privileges or the like. The read only customer database access module 228 is the primary method that the mobile access services layer uses to retrieve information from the customers databases. The module 228 is read only to insure an extra layer of database protection. The read only customer database access web service 229 is used by the mobile access services layer 208 to retrieve information from the customer databases that are remote or not directly accessible to the supporting web service module 225.

The mobile access services layer 208 provides appropriate configuration information to the mobile database device which may include downloading of a mobile database thin client program, and set up of standard reporting forms, print forms, customer specific prearranged settings, and the like. For example, the customer specific prearranged settings may include menus, reporting forms, input forms, a brief description or icon for structured query language (SQL) code snippets that are available for the specific user for report queries and data queries, and the like. The mobile access services layer 208 provides a mechanism for the mobile access client to access information for the report queries and the data queries from the customer database 234 in the customer specific layer 210. For security purposes, the access to the customer database 234 are generally read only.

The customer specific layer 210 allows the customer to extend the functionality of the mobile access services and to access information not available by standard (SQL) query methods using the read only modules 228 and 229. Read only module 228 provides a read only customer database access SQL query service. Read only web service module 229 is similar to read only module 228 with additional capability to allow a query to be executed on a remote server. For example, the read only web service module 229 is used to provide access for queries for databases not accessible by a primary web service due to security, physical location, or network configuration. The customer specific layer 210 comprises a customer forms input processing web service 232, an optional third party application programming interface (API) or web service 233, and customer database 234. The customer forms input processing web service 232 provides two distinct functions. First, upon request, the web service 232 provides configuration to the supporting web service 225 about the functionality it is providing and configuration information specific to its use of the customer specific layer 210. Second, the web service 232 executes the data service requests made to it by the supporting web service 225 for the execution and processing of requests made to it by the mobile access client 204. The third party API or web service 233 provides access to reading and updating database information upon request by the customer forms input processing web service 232, that are not normally available using standard SQL query statements or when it is desirable to utilize the services of an existing API code module, which in may situations may be provided by a third party vendor. Further, the customer database 234 stores customer specific information from which database segments may be copied and downloaded onto a mobile database device 102. It is anticipated that with support for multiple customers, multiple customer specific databases would be supported.

The customer specific layer 210 may provide access for the reporting queries for databases not accessible by a primary web service due to security, physical location, or network configuration. The customer specific layer 210 also provides the capability for the mobile database device to update the client database based upon inputs from the remote device. A client may write or purchase third party API or web service 233 to support the client's own applications. The customer forms input processing web service 232 supports the access of input form definitions to allow input forms to be generated based on a customer application.

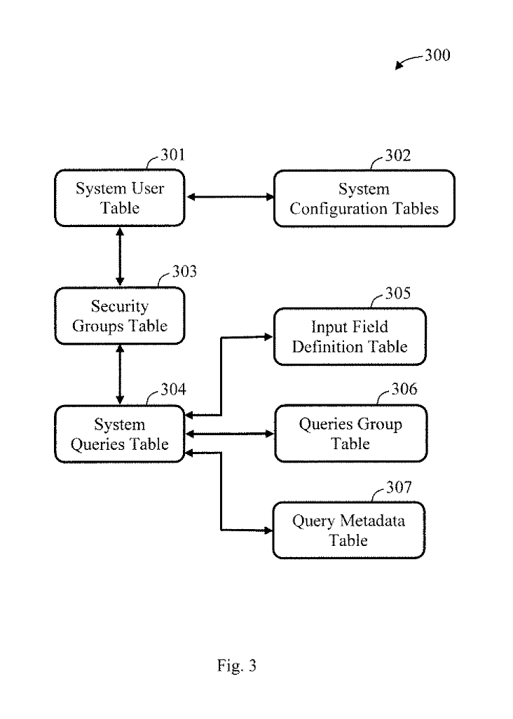

FIG. 3 illustrates a mobile organized setup, control, and configuration database 300 of exemplary system configuration tables 301-307 in accordance with the present invention. The paths between the various system configuration tables 301-306 represent authorized access paths. The system users table 301 lists authorized users for the mobile database system. The system configuration tables 302 identifies mobile database device hardware and software configuration in support of validating a user's mobile database device. The security groups table 303 lists specific queries that are available to the authorized users listed in the system users table 301. The system queries table 304 lists multiple types of queries each of which are assigned to a security group listed in the security groups table 303. The queries listed in the system queries table 304 determine the type of information that is returned to a user. System reports may be generated and grouped as menu tree entries which are accessible by assigning multiple system queries together in groups that are listed in query groups table 306.

Thus, a system query is assigned to a query group. Since may queries require input to specify what data the user is looking for, user input fields are defined and listed in input field definition table 305. Once an input field is defined, the input field definition may then be referenced by one of the system queries listed in the system queries table 304. The query metadata table 307 lists specific metadata entries associated with each of the system queries listed in the system queries table 304. In a preferred embodiment, the configuration tables 301-307 are located in the configuration database 227 of FIG. 2. In an alternate embodiment, for a tightly integrated solution with a vertical software product, the configuration tables 301-307 may be located directly in a customer specific database 234.

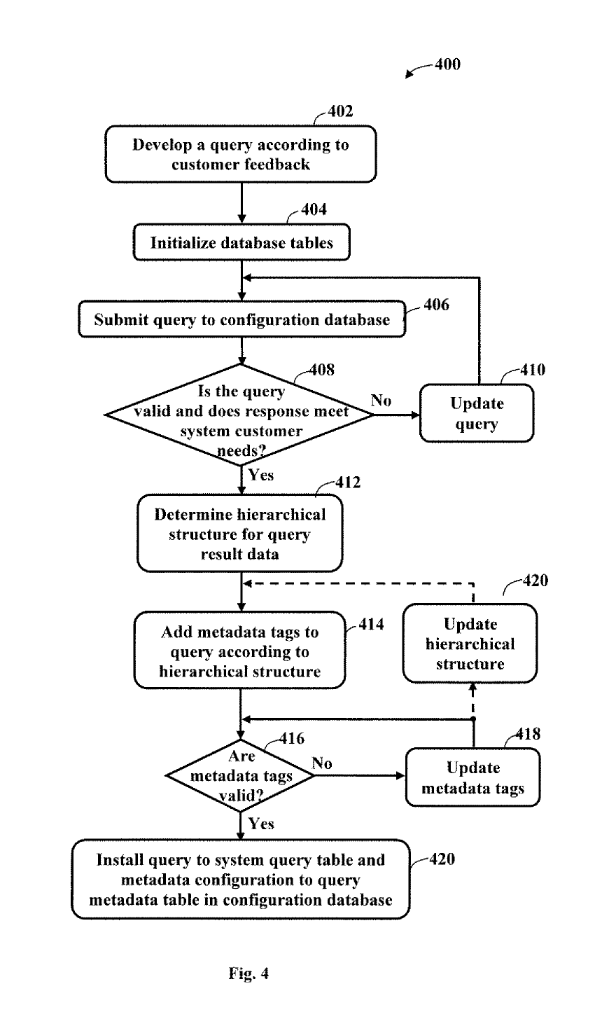

FIG. 4 illustrates a query configuration process 400 in accordance with the present invention. The query configuration process 400 is used to create, for example, a set of queries, associated hierarchical data structures, and contents of one or more relational database snippets for a user of the mobile database system. A database snippet is a subset or fragment of a customer database. Contents of the database snippet include additional information that exceeds individual specific requests for information by a user of the system. The contents and organization of the contents of a database snippet depend upon customer feedback concerning a particular job or activity supported by the mobile database system, as described in more detail below. The database snippet in accordance with the present invention contains more information as compared to a conventional approach which would typically return the requested information. The database snippet is also in contrast to such systems that generally bundle information to be sent to a user, since the database snippet in accordance with the present invention is tailored by customer feedback to a specific user. Conventional solutions require a user to make a query request that will obtain some results, but in many cases, these results are not sufficient for the user's needs and the user is required to make numerous additional query requests until they find the needed piece of information. Under an embodiment of the present invention, a server would be configured to return additional information in a database snippet along with an initial query request results, but hide the additional information until the user makes actions to view the hidden data. In contrast to conventional methods, the user may access the additional information hidden in the database snippet, without the need to make any further server requests. The response to the user's request for some or all of the additional information would be much faster than conventional methods and provided without the user even realizing that the request was handled locally.

The query configuration process 400 begins at step 402. At step 402, a query is developed by a query developer based on customer feedback, customer interviews, and the like, to determine what information is required in a particular job or activity and how that information may be organized for efficient user access. For example, different aspects of a job may require different information needs and different organizations of data. For each aspect, a database snippet may be outlined based on customer feedback that would solve a high percentage of the user's specific information needs. At step 404, supporting elements, such as database tables, are initialized.

At step 406, the query developer submits a prepared query. At decision step 408 the query is checked as being a valid query with, for example, valid user input fields filled out. At step 408, the response from the customer database 234 of FIG. 2 to the query is verified whether the information returned would meet a system customer's needs. If the query is not valid or if the response would not meet a system customer's needs, the process 400 proceeds to step 410. At step 410, the query that was submitted is updated and the process 400 returns to step 406 to resubmit the updated query. Returning to decision step 408, if the query is valid and the response meets a system customer's needs, the process 400 proceeds to step 412.

At step 412, a hierarchical structure is determined for the query result data based on customer feedback for efficient user access of information. At step 414, metadata tags, as described further below, are added to a query according to the developed hierarchical structure. Steps 412 and 414 also allow the query developer to add a metadata tag or change an existing metadata tag. At decision step 416, a determination is made whether the metadata tags are valid. For example, the metadata tags are checked against system rules which may include validating metadata tag names against defined or available system tag names. Also, a number of metadata tags may include values with ranges, specified by a user. In such cases, the ranges are compared against system specified ranges. If a metadata tag references another column in the hierarchical structure, a check is made to ensure the referenced column has been defined. If the metadata tags are not valid, the process 400 proceeds to step 418. At step 418, the metadata tags are updated based on operator input and the process 400 generally returns to decision step 416 to make a new determination of validity on the updated metadata tags. In a number of scenarios, the hierarchical structure needs to be updated as well as the metadata tags and the process proceeds to step 420. At step 420, the hierarchical structure is updated and the process 400 proceeds to step 414, where the metadata tags are updated according to the updated hierarchical structure.

Returning to decision step 416, if the metadata tags are valid, the process 400 proceeds to step 420. At step 420, the query is installed in a system query table and metadata configuration is saved to a query metadata table in the configuration database 227 of FIG. 2.

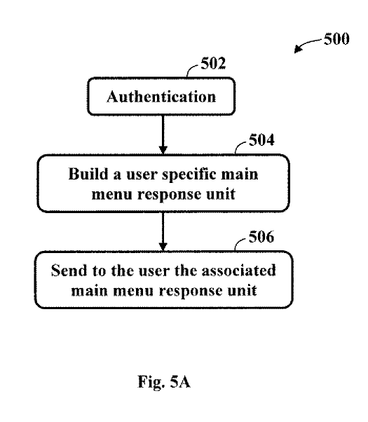

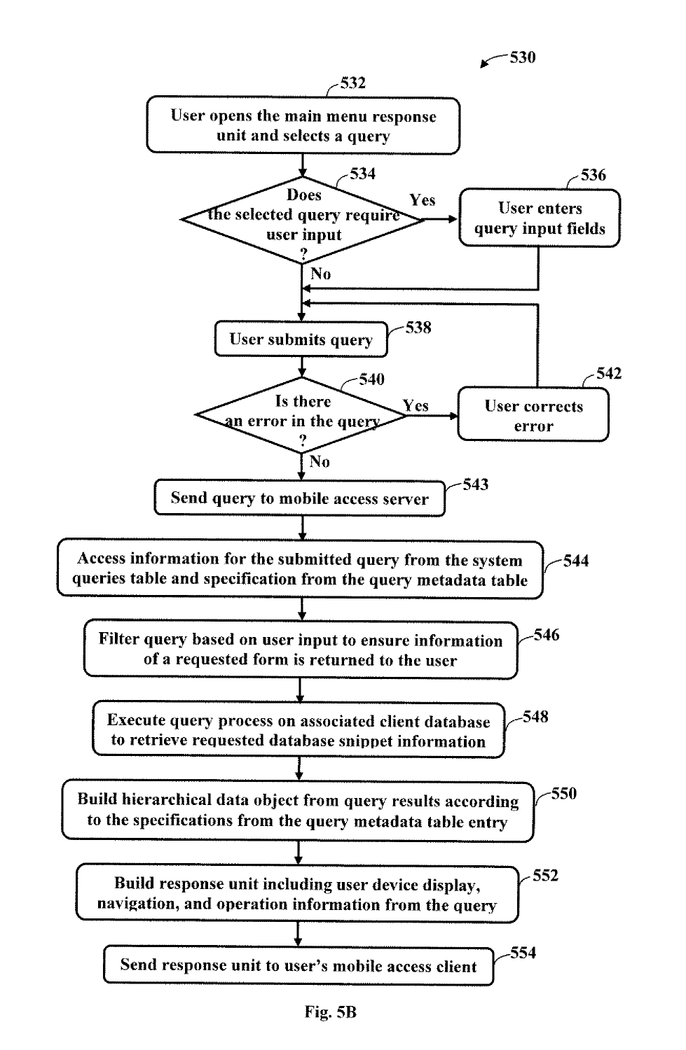

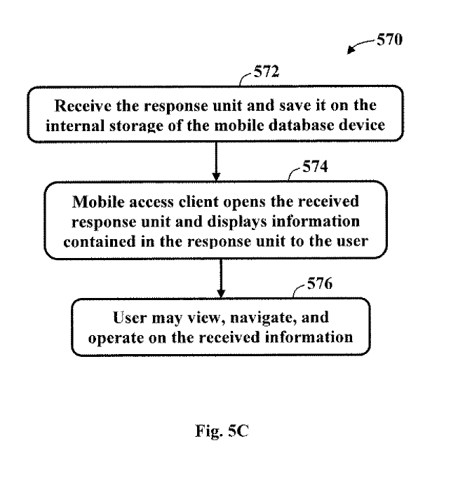

FIG. 5A illustrates an exemplary mobile access authentication and startup process 500 in accordance with the present invention. At step 502, a user selects the mobile access client 204 of FIG. 2 on the user's mobile database device 102 of FIG. 1. The mobile access client 204 requests user information, such as a user identification and password. An authentication request is formed and sent to the mobile security layer 206 of FIG. 2, operating, for example on mobile security device 106 of FIG. 1. If proper security parameters are met, the authentication request is sent to the mobile access services layer 208 of FIG. 2 of the mobile access server 110 of FIG. 1. The mobile access services layer 208 then searches for the user in the system users table 301 of FIG. 3 in response to the authentication request. The user's credentials are validated with respect to credential values stored in the system configuration table 302. If the user cannot be found in the system configuration tables 302 or the credentials are not validated the authentication request is flagged as a possible unauthorized access. With validation, the process 500 proceeds to step 504.

At step 504, the mobile access services layer 208 of FIG. 2 utilizes the user authentication information and determines the queries the user is allowed to access. The user queries are determined by linking from the user entry in the system user table 301 to the user entry in the security group table 303, and then linking to the user entry in the system queries table 304 which identifies the allowed queries for this user. The mobile access services layer 208 then builds a main menu response unit having a listing for each of the user assigned system queries from the system queries table 304. The listing includes information about what input information is required by the user to activate each of the system queries in the listing. At step 506, the main menu response unit is then sent to the mobile access client 204 of the mobile database device 102 of FIG. 1. This allows the user to enter the query input information without having to access the mobile access services layer 208 when a query is selected. It is noted that the main menu response unit may include information about query groups as determined by a link to queries group table 306 and input field definitions as determined from a link to the input field definition table 305. The main menu response unit is received by the mobile access client 204 and saved on internal storage of the processor complex 120 in the mobile database device 102.

FIG. 5B illustrates an exemplary mobile query process 530 in accordance with the present invention. At step 532, a user opens the main menu response unit and selects a query from the mobile database device 102 of FIG. 1. At decision step 534, a determination is made by the mobile access client 204 of FIG. 2 whether the selected query requires user input. If user input is required, the process 530 proceeds to step 536. At step 536, the mobile access client 204 displays input fields that are required and the user enters the input fields required by the selected query. At step 538, the user submits the query which causes the mobile access client 204 to validate the inputs against local validation rules. If any error is detected, the process 530 proceeds to step 542. At step 542, an error message is returned to the user for correction. Generally, the user corrects the error, such as an error in user input, and the process 530 returns to step 538 to resubmit the query.

Returning to decision step 540, if no error was detected, the process 530 proceeds to step 543. The mobile access client 204 will package the query inputs along with information to identify the query, user, and user's mobile database device 102 and forward the query through the mobile security layer 206 to the mobile access services layer 208 of FIG. 2. At step 543, the query is sent to the mobile access services layer 208 of FIG. 2 in the mobile access server 110 of FIG. 1. At step 544, the mobile access services layer 208 accesses information associated with the submitted query from the system queries table 304 and the query metadata table 307. At step 546, the submitted query is filtered to select the desired information requested by the user for use in building the database snippet to be returned to the user. For example, if a customer supports a large region that is divided up into subregions each supported by an individual employee user, a query for a particular user may be filtered to provide information specific to the subregion the user supports. At step 548, the submitted query is executed by an execution query process on a client database associated with the user's submitted query to retrieve a requested database snippet. At step 550, a hierarchical data object is built from query results, such as the requested database snippet, according to the specifications retrieved from the query metadata table 307. At step 552, the mobile access services layer 208 builds a response unit based on information from the query metadata entry that includes device display, navigation, and operation information, as obtained from the query metadata table 307, for the hierarchical data object being returned to the user's mobile access client 204 of FIG. 2. At step 554, the response unit is sent to the user's mobile access client 204 in the mobile database device 102 of FIG. 1.

FIG. 5C illustrates an exemplary mobile access receive and operate process 570 in accordance with the present invention. At step 572, the response unit is received and saved on the internal storage of the processor complex 120 of the mobile database device 102 of FIG. 1. At step 574, the mobile access client 204 opens the received response unit and displays information contained in the response unit to the user. At step 576, the user may view, navigate, and operate on the received information contained in the requested database snippet. It is noted that once response units are received and saved on the mobile database device 102, they may be reopened and reviewed at the discretion of the user, at a later time, without subsequent or further server activity.

Another embodiment of the invention includes the specification of data to be returned to a user in response to a specific query. The data to be returned includes additional information beyond the immediate query request based on anticipated user needs. Thus, a user's anticipated subsequent queries that are related to the initial query may be satisfied locally at the mobile database device 102 rather than requiring successive and possibly repetitive database queries for the additional information. The information returned to the user may be advantageously displayed without the need for specific user device display forms. For example, the mobile thin client 214 of FIG. 2 operates the display 217 in one of three selected modes. A first mode comprises a listing format in which database entries are displayed with column names across the top of the display and the data presented in rows associated with the column names. The user may then select a particular row or entry in a row to have more detailed information presented about the selection. A second mode comprises a summary format in which a selected row or entry in a row is displayed with identifying title information on the left side of the display and related data following the title. The summary format advantageously is able to display virtually unlimited information about the selected row or entry in a row. The user may scroll through the selected data. A third mode comprises an input format in which a modified summary format is used to display requests for user information such as the filing of input fields for a query, such as city, state, and zip codes.

A submitted query is associated with metadata entries in the query metadata table 307. Metadata attributes and tags are assigned to query data columns and elements by a system administrator or a person who configures the system. Such an individual also determines the additional information based on predetermined anticipated user needs. The metadata attributes and tags indicate to the mobile access client 204 how to display the data, navigate through a query result, and may include authorization enabling links to external data sites, such as a street mapping service for example. The metadata attributes and tags may also cause input data forms to appear with automatic data entry of input information as related to a selected data entry.

An embodiment of the present invention includes structuring requested information in a hierarchical organization with levels of the hierarchy identified by the metadata attributes and tags. The use of hierarchical data objects allows a query to return additional information from a database which can then be accessed and navigated by the user as desired. For example, hierarchical levels may be indentified in specific fields as levels one to N. A primary key may be used to identify data relationships, such as identifying a parent entry for possible successive children entries. A foreign key is used to link related child entries to their parent entries by matching the value of the foreign key to the respective primary key with a matching value.

Display orientation tags may also be assigned to data to be returned in response to a query. A display orientation tag of “listing (L)” causes the data to be displayed in the listing format. A display orientation tag of “summary (S)” causes the data to be displayed in the summary format. A listing and summary combination tag (LS) may be used for a selected column or element entry to be displayed in both the listing and summary formats. This approach allows a specific query column or element to be displayed in the initial listing format, and also be included in a subsequent summary format for the same entry. A hidden tag (h) may also be specified to prevent a particular entry from displaying, for example, on any display screen. The hidden tag is useful for hiding internal data elements, such as a primary key (p), a foreign key (f) and the like, from the user that take up valuable display screen space. Display order tags may be used to force an order in which the column and elements are displayed. Also a table column width tag may be used to specify the column width on the display screen.

Additional display formatting tags may used to specify how particular data is to be displayed and may include:
a. left justified—show the data rightjustified in the screen area for the element
b. right justified—show the data right justified in the screen area for the element
c. center justified—show the data centered in the screen area for the element
d. dollar—format the data as dollars and cents, with commas and periods
e. numeric—# format at integer, with commas
f. SSN—format as Social Security Number, with dashes
g. date—format as date field in MM/DD/YYYY format (or as appropriate for location)
h. no wrap—do not wrap data to additional display lines if display length is exceeded
i. wrap—wrap data if display length for the element is exceeded
j. multiple line—field is a multiple line entry, wrap text at new line or break
k. attribute—attribute for field of same name, which can be used to dynamically add attributes or names to the referenced column. Attributes may include, but are not limited to:
   i. color
   ii. intensity
   iii. font size
l. title—display the data for the element as title for field of same name which can be used to dynamically add a label or a title to, for example, a Jump link or the like.
m. picture—show the field data as a picture.
n. column width tags—may be used to limit the display space taken up by a column.
o. display or header name for data element—which may default to a column name without attribute information, but may be overridden.
p. use information for help—prompting information.

Action tags may also be specified to indicate to the mobile access client 204 any special effects associated with a data object such as:
a. jump—causes the display to move or jump to the primary key referenced by the foreign key of the specified data element
b. URL—opens a browser window to the uniform resource locator (URL) specified by the data element
c. input form—used to jump to an input request display screen to capture requested user input and where the display screen may be auto-populated according to an associated hierarchical data object entry
d. input name used to indicate that the element can be used to auto-populate input forms of the system

For example, a user, such as a motor vehicle department employee, has an initial request for a listing of licenses with expiration dates within a specified range and of a specific type. To fulfill such a request, a database query process is used that identifies and retrieves the requested information and additional information that is anticipated to be needed by the user, as described in more detail below.

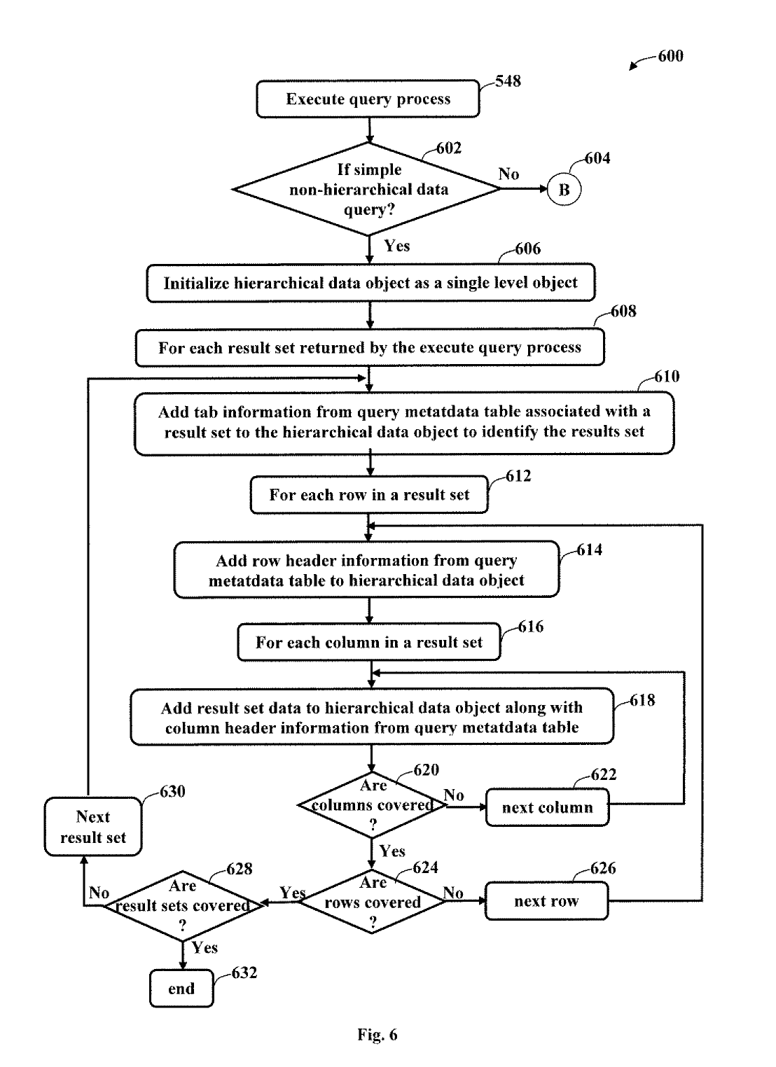

FIG. 6 illustrates an exemplary non-hierarchical, such as a flat single line report type format, query execution process 600 in accordance with the present invention. The execution process 600 is one suitable approach for carrying out step 550 of FIG. 5B, where a hierarchical data object is built from query results, such as the requested database snippet, according to the specifications retrieved from the query metadata table 307. At step 548, a query is executed on an associated client database as discussed above in connection with FIG. 5B. At decision step 602, a determination is made whether the query is a simple non-hierarchical data query, using information from the system queries table 304. If the query is a simple non-hierarchical data query, then the execution process 600 proceeds to step 606. At step 606, an internal hierarchical data object is initialized as a single level object to accommodate a non-hierarchical query response. At step 608, a processing loop is set up for each result set returned by the execute query process of step 548. At step 610, tab information from query metadata table 307 associated with the result set is added to the hierarchical data object to identify the result set. A tab is a place holder for an entry into the hierarchical object that can also be used as a display or control element on the display screen of the mobile database device 102 to allow a user to select the entry. For example, in one embodiment, a tab may function as a computer index tab or a file folder. At step 612, a processing loop is set up for each row in a result set. At step 614, row header information obtained from query metadata table 307 is added to the hierarchical data object. At step 616, a processing loop is set up for each column in a result set. At step 618, result set data is added to the hierarchical data object along with column hear information obtained from the query metadata table 307.

At decision step 620, a determination is made whether all columns in a result set are covered. If all columns are not covered, the execution process 600 proceeds to step 622. At step 622, the next column of information is accessed and the execution process 600 returns to step 618. Returning to decision step 620, if all columns are covered, the execution process 600 proceeds to decision step 624. At decision step 624, a determination is made whether all rows in a result set are covered. If all rows are not covered, the execution process 600 proceeds to step 626. At step 626, the next row of information is accessed and the execution process 600 returns to step 614. Returning to decision step 624, if all rows are covered, the execution process 600 proceeds to decision step 628. At decision step 628, a determination is made whether all result sets are covered. If all result sets are not covered, the execution process 600 proceeds to step 630. At step 630, the next result set is accessed and the execution process 600 returns to step 610. Returning to decision step 628, if all result sets are covered the process ends at step 632.

For example, the motor vehicle department employee user submits a query to request information for a listing licenses of a specific type having expiration dates within a specific range. In response to the user's query an internal query is formed that requests additional information that exceeds the individual specific user request for information. For example, customer feedback had previously indicated that for a user query for this type of information, the user may also require a listing of licenses of this type with expiration dates in a larger range beyond the specific range requested. Also, for each license in the expanded range information regarding vehicle owner, address, phone number, and fees due, for example. Also, based on the previous customer feedback, this information may be simply arranged in a non-hierarchical manner as a listing. An SQL query may be advantageously tagged using brackets, for example, in a row column organization, a bracketed tag may be used to indicate a column name and presentation information on how to display the tagged entry. For example, a [_nL_License #]=SQL line entry to “full credential” may be used to identify a column for license numbers, and displayed in an “nL” format of no-wrap listing format, as defined above. The underscores in the above example identify field formatting control characters that are removed prior to display. In another example, [_$S_Fees Due] causes “Fees Due” to be displayed as the column name with an entry value formatted as dollars and cents, right justified by definition of the money ($) format, and to be displayed when the operator selects the summary mode by definition of the summary (S) format. Also, less than < and greater than > symbols are used to indicate input control fields for values to be filled in by a mobile database device user. Tagging an SQL query line provides a way of associating a tag with a result produced in response to the query line so that the result may be tagged prior to sending the result to the mobile database device for display and response, as indicated by the tag.

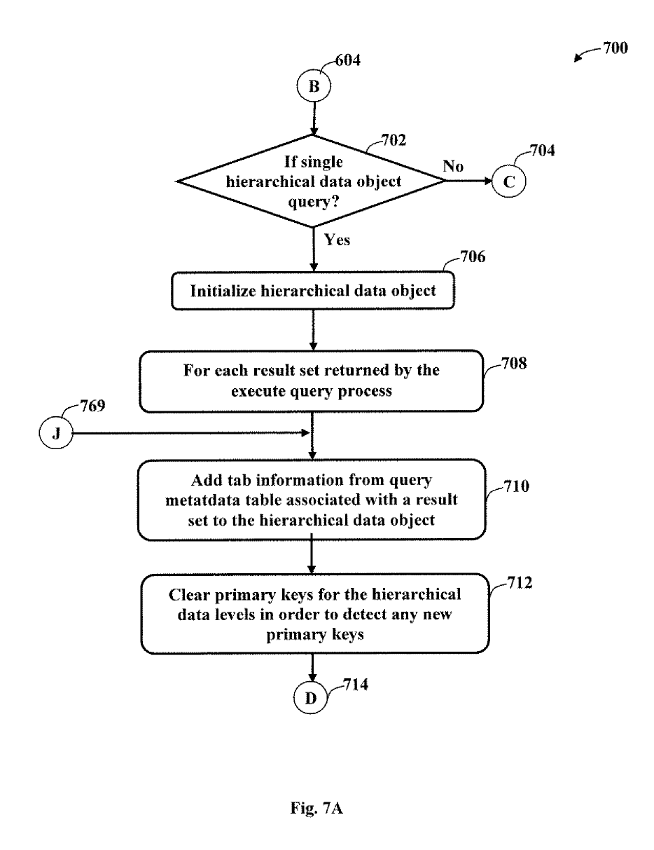

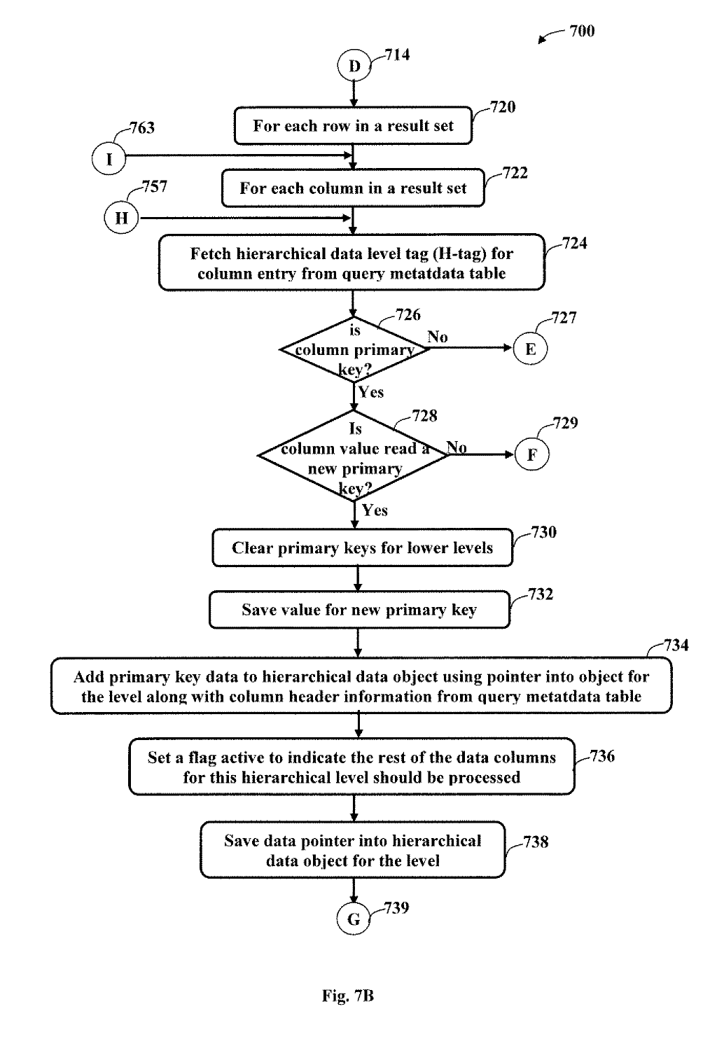

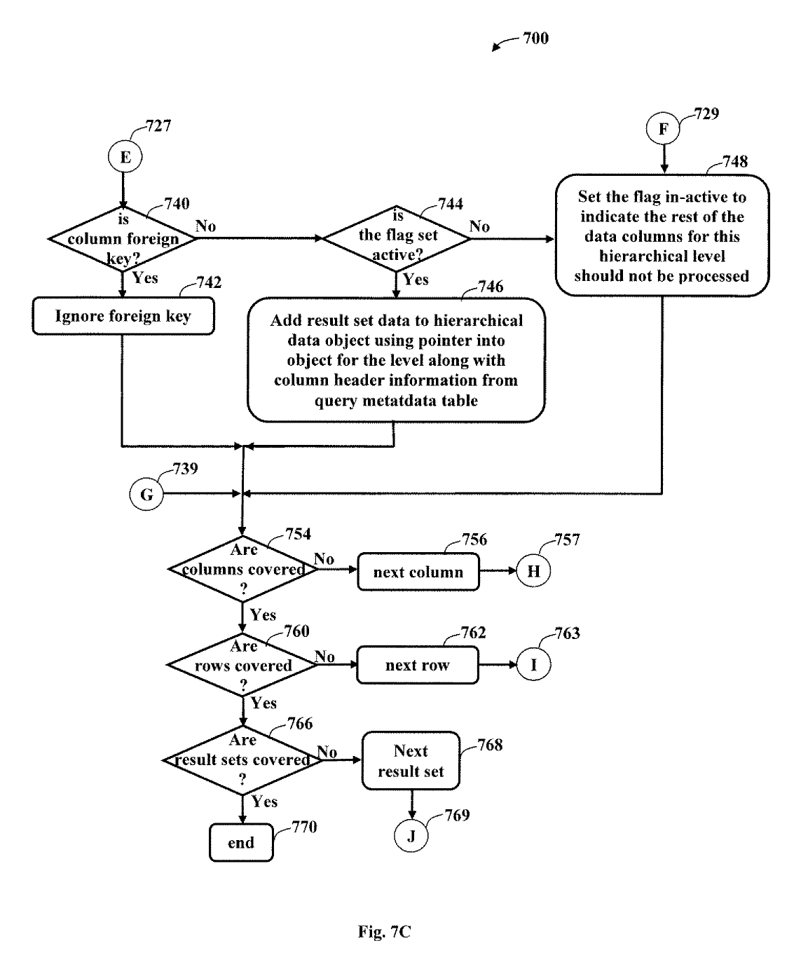

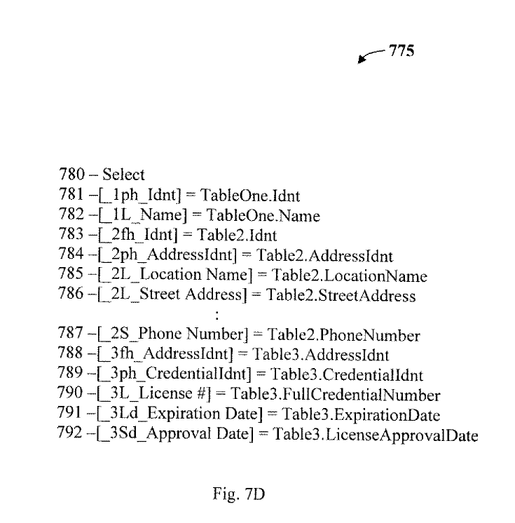

FIGS. 7A-7C illustrate an exemplary single hierarchical data object query execution process 700 in accordance with the present invention. The execution process 700 is another embodiment of step 550 of FIG. 513, where a hierarchical data object is built from query results, such as the requested database snippet, according to the specifications retrieved from the query metadata table 307. Returning to decision step 602 of FIG. 6, if the query is not a simple non-hierarchical data query, then the execution process 600 proceeds through connection point B 604 to decision step 702 of FIG. 7A. At decision step 702, a determination is made whether the query is a single hierarchical data object query, using information from the system queries table 304. If the query is a single hierarchical data object query, the execution process 700 proceeds to step 706. At step 706, an internal hierarchical data object is initialized, for example, keys are placed in a default cleared state. At step 708, a processing loop is set up for each result set returned by the execute query process of step 548. At step 710, tab information from query metadata table 307 associated with the result set is added to the hierarchical data object. At step 712, primary keys for the hierarchical data levels are cleared in order to detect primary keys changes in the result set. The execution process 700 proceeds through connecting point D 714 to step 720 of FIG. 7B.

At step 720, a processing loop is set up for each row in a result set. At step 722, a processing loop is set up for each column in a result set. At step 724, a hierarchical data level tag (H-tag) is fetched for column entry from the query metadata table 307. At decision step 726, a determination is made whether the H-tag indicates a primary key for the column. If the H-tag is a primary key, the execution process 700 proceeds to decision step 728. At decision step 728, a determination is made whether the value read for the primary key column is a new primary key by comparison with a saved primary key column value for this level. If the comparison indicates a new primary key, the execution process 700 proceeds to step 730. At step 730, the primary keys for lower hierarchical levels are cleared such that the remaining primary keys in the row are processed as new primary keys. For example, in processing data for companies, when a switch is made from company A to company B, the primary keys for addresses and employee data for company A are cleared since the addresses and employee data for company B are different.

At step 732, the new primary key value is saved, for subsequent use by step 728. In particular, the new primary key value is saved relative to the hierarchical level it represents. For example, company A has a primary key value of 1 and company B has a primary key value of 2. Thus, the primary key value is saved in order to determine when the primary key value has changed to a new value during the processing of query result structure. At step 734, the primary key value is added to the hierarchical data object using a pointer into the object that is appropriate for the hierarchical level of the primary key being processed. Along with the primary key data, column header information obtained from the query metadata table 307 is also added. At step 736, a flag is set active to indicate the rest of the data columns for this hierarchical level should be processed. The execution process 700 then proceeds to connection point G 739. The execution process 700 then proceeds to decision step 754.

Returning to decision step 726, if the H-tag is not a primary key, the execution process 700 proceeds to connection point E 727. At decision step 740 in FIG. 7C, a determination is made whether the H-tag is a foreign key. If the H-tag is a foreign key, the execution process 700 proceeds to step 742. At step 742, the foreign key is ignored as not appropriate for this execution process 700 at this point in the process. The execution process 700 then proceeds to decision step 754. Returning to the decision step 740, if the H-tag is not a foreign key, the execution process proceeds to decision step 744. At decision step 744, a determination is made whether the flag is set active by steps 736 or 748 for the hierarchical level of this column. If the flag is set active, the execution process 700 proceeds to step 746. At step 746, the result set data is added to the hierarchical data object using a pointer into the object for the level along with column header information obtained from the query metadata table 307. The execution process then proceeds to decision step 754.

Returning to decision step 728, if the comparison indicates the primary key is not a new primary key, the execution process 700 proceeds to connection point F 729. At step 748 in FIG. 7C, the flag is set inactive to indicate the rest of the data columns for this hierarchical level should not be processed. The execution process then proceeds to decision step 754.

At decision step 754, a determination is made whether all columns in a result set are covered. If all columns are not covered, the execution process 700 proceeds to step 756. At step 756, the next column of information is accessed and the execution process 700 proceeds to connection point 757 to step 724 of FIG. 7B. Returning to decision step 754, if all columns are covered, the execution process 700 proceeds to decision step 760. At decision step 760, a determination is made whether all rows in a result set are covered. If all rows are not covered, the execution process 700 proceeds to step 762. At step 762, the next row of information is accessed and the execution process 700 proceeds to connection point I 763 to step 722 of FIG. 7B. Returning to decision step 760, if all rows are covered, the execution process 700 proceeds to decision step 766. At decision step 766, a determination is made whether all result sets are covered. If all result sets are not covered, the execution process 700 proceeds to step 768. At step 768, the next result set is accessed and the execution process 700 proceeds to connection point J 769 to step 710 of FIG. 7A. Returning to decision step 766, if all result sets are covered the process ends at step 770.

FIG. 7D illustrates exemplary tagged SQL select entries 775 for formatting query results in a hierarchical organization in accordance with the present invention. The line entries 780-792 represent a single query that provides a single result set. As a single query result set the hierarchical level appropriate for each entry is specified. Line entry 780 specifies a select operator. Line entry 781 uses a tag [_{—}1ph_Idnt] that identifies selected results from TableOne.Idnt as a first level of a hierarchy having a primary key (p) that is hidden (h) and named for mobile database device referencing purposes as “Idnt”. Line entry 782 uses a tag [_{—}1L_Name] that identifies selected results from TableOne.Name as a first level entry of the hierarchy to be listed (L) in association with “Name” on the display 121 of the mobile database device 102. Line entry 783 uses a tag [_{—}2fh_Idnt] that identifies selected results from Table2.Idnt as a second level entry of the hierarchy having a foreign key (f) that is hidden (h) and provides a link to the “Idnt” from TableOne of line entry 781. Line entry 784 uses a tag [_{—}2ph_AddressIdnt] that identifies selected results from Table2.AddressIdnt as a second level entry of the hierarchy having a primary key (p) that is hidden and named for mobile database device referencing purposes as “AddressIdnt”. Line entry 785 uses a tag [_{—}2L_Location Name] that identifies selected results from Table2. LocationName as a second level entry of the hierarchy to be listed (L) in association with “Location Name” on the display 121 of the mobile database device 102. Line entry 786 uses a tag [_{—}2L_Street Address] that identifies selected results from Table2.StreetAddress as a second level entry of the hierarchy to be listed (L) in association with “Street Address” on the display 121 of the mobile database device 102. Line entry 787 uses a tag [_{—}2S_Phone Number] that identifies selected results from Table2.PhoneNumber as a second level entry of the hierarchy to be shown in summary format (S) in association with “Phone Number” on the display 121 of the mobile database device 102.

It is noted that the second level entries are additional information, more than originally requested, that are returned to the mobile database device 102 in response to the initial user query and in anticipation of future needs by the user. Thus, any further action by host servers, such as servers 10 and 128, is advantageously not required should the user need to access the additional anticipated information. For example, further action which would not be required includes additional query submissions, transmissions to the mobile access server 110, accesses of customer databases in customer application server databases 128, processing of query results, and transmissions of the processed query results back to the mobile database device 121. By reducing the number of transmissions between the mobile database device and the supporting host servers, such as servers 110 and 128, which may be out of communication range when the additional information is needed, the user's work flow becomes more efficient and not limited by a communication infrastructure.

Returning to FIG. 7D, line entry 788 uses a tag [_{—}3fh_AddressIdnt] that identifies selected results from Table3AddressIdnt as a third level entry of the hierarchy having a foreign key (f) that is hidden (h) and provides a link to the “AddressIdnt” from Table2 of line entry 784 which uses a primary key in the tag and the same name of “AddressIdnt”. Line entry 789 uses a tag [_{—}3ph_CredentialIdnt] that identifies selected results from Table3.CredentialIdnt as a third level entry of the hierarchy having a primary key (p) that is hidden and named for mobile database device referencing purposes as “CredentialIdnt”. Line entry 790 uses a tag [_{—}3L_License #] that identifies selected results from Table3.FullCredentialNumber as a third level entry of the hierarchy to be listed (L) in association with “License #” on the display 121 of the mobile database device 102. Line entry 791 uses a tag [_{—}3Ld_Expiration Date] that identifies selected results from Table3.ExpirationDate as a third level entry of the hierarchy to be listed (L) in date format (d) in association with “Expiration Date” on the display 121 of the mobile database device 102. Line entry 792 uses a tag [_{—}3Sd_Approval Date] that identifies selected results from Table3LicenseApprovalDate as a third level entry of the hierarchy to be shown in summary (S) and date (d) format in association with “Approval Date” on the display 121 of the mobile database device 102. It is noted that the third level entry of “Approval Date” represents additional information, more than originally requested, that is returned to the mobile database device 102 in response to the initial user query and in anticipation of future needs by the user. Thus, further communication and processing by supporting host servers, such as servers 110 and 128 are advantageously not required for a specific query for an approval date.

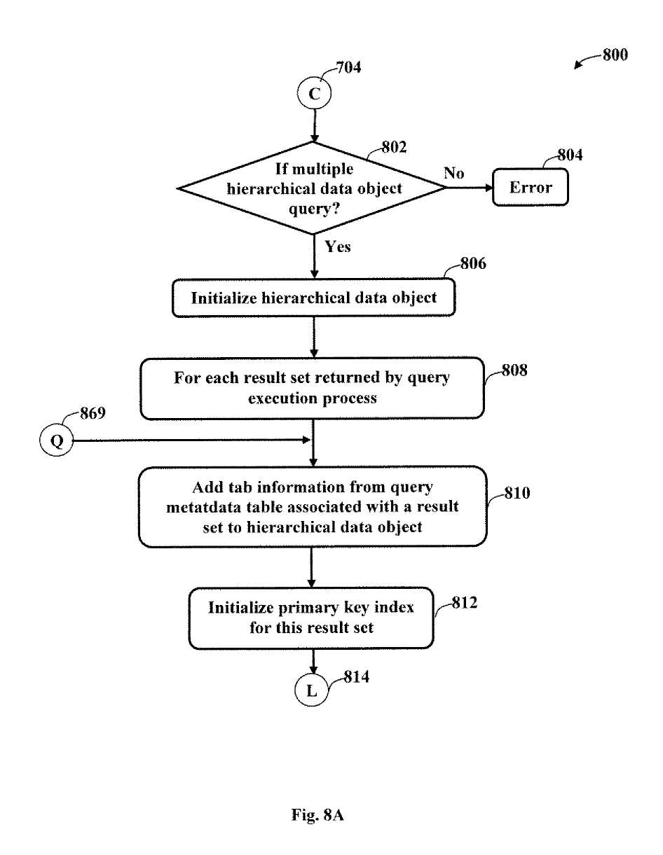

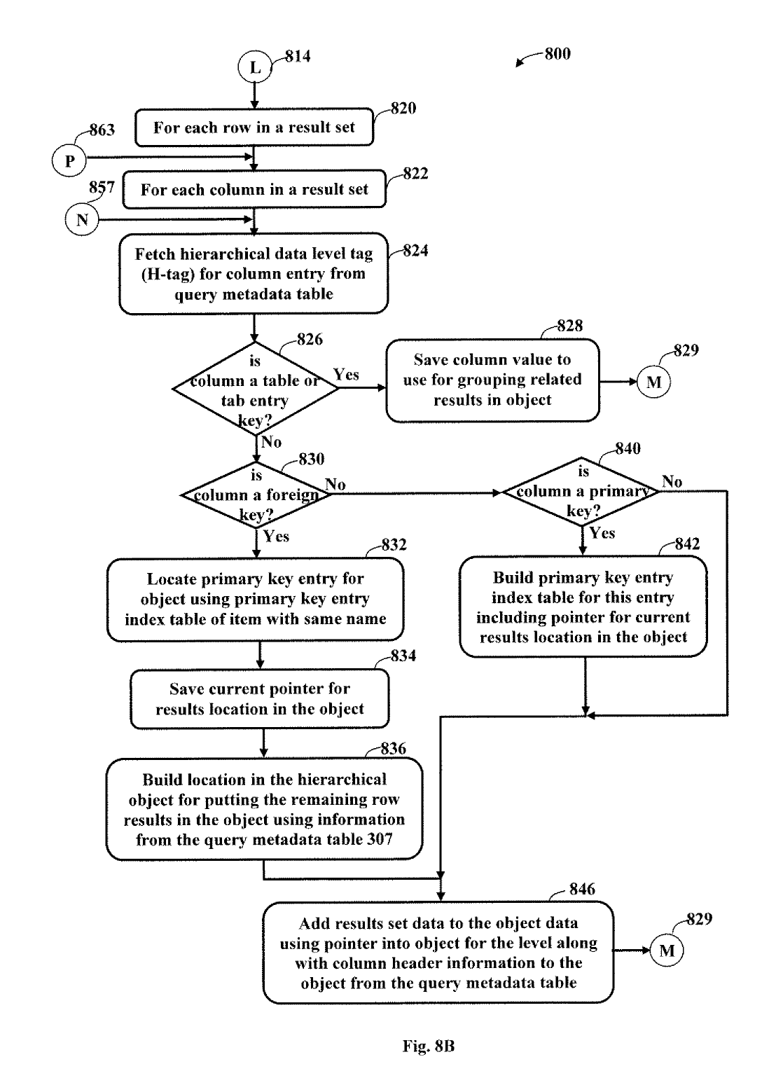

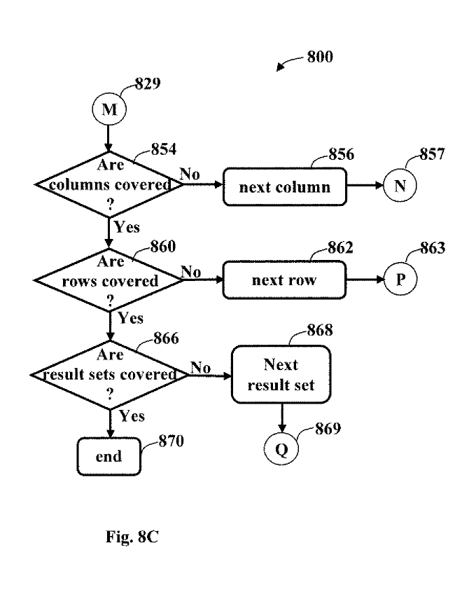

FIGS. 8A-8C illustrate an exemplary multiple hierarchical data object query execution process 800 in accordance with the present invention. The execution process 800 is another embodiment of step 550 of FIG. 5B, where a hierarchical data object is built from multiple query results, such as the requested database snippet, according to the specifications retrieved from the query metadata table 307. Returning to decision step 702 of FIG. 7A, if the query is not a single hierarchical data query, then the execution process 700 proceeds through connection point C 704 to decision step 802 of FIG. 8A. At decision step 802, a determination is made whether the query is a multiple hierarchical data object query. If the query is a multiple hierarchical data object query, the execution process 800 proceeds to step 806. At step 806, an internal hierarchical data object is initialized, for example, keys are placed in a default cleared state. At step 808, a processing loop is set up for each result set returned by the execute query process of step 548. At step 810, tab information from query metadata table 307 associated with the result set is added to the hierarchical data object. At step 812, a primary key index for this result set is initialized. The execution process 800 then proceeds through connection point L 814 to step 820 of FIG. 8B.

At step 820, a processing loop is set up for each row in a result set. At step 822, a processing loop is set up for each column in a result set. At step 824, a hierarchical data level tag (H-tag) is fetched for a column entry from the query metadata table 307. At decision step 826, a determination is made whether the H-tag indicates the column is a table or tab entry key. If the H-tag indicates the column is a table or tab entry key, the execution process 800 proceeds to step 828. At step 828, the column value is saved to use for grouping related results in the hierarchical data object. The execution process 800 then proceeds through connection point M 829 to decision step 854.

Returning to decision step 826, if the H-tag indicates the column is not a table or tab entry key, the execution process 800 proceeds to decision step 830. At decision step 830, a determination is made whether the H-tag indicates the column is a foreign key. If the H-tag indicated the column is not a foreign key, the execution process proceeds to decision step 840. For example, the first time through the loop, a primary key would be encountered before a foreign key according to system referencing rules. At decision step 840, a determination is made whether the H-tag indicates the column is a primary key. If the H-tag indicates the column is a primary key, the execution process 800 proceeds to step 842. At step 842, a primary key entry index table is built for this entry including a pointer for current results location in the hierarchical data object, to facilitate the primary key lookup of step 832. The execution process 800 then proceeds to step 846.

Returning to decision step 830, if the H-tag indicates the column is a foreign key, the execution process 800 proceeds to step 832. At step 832, a primary key entry for the hierarchical data object is searched for using the primary key entry index table from step 842 of an item with the same name. At step 834, a pointer for results location in the hierarchical data object is saved as the current pointer for use by step 836 and step 846. The current pointer is used to identify a location for inserting other items in the hierarchical data object. At step 836, the location in the hierarchical data object is built for inserting the remaining row results in the hierarchical data object using information from the query metadata table 307. The execution process 800 then proceeds to step 846.

Returning to decision step 840, if the H-tag indicates the column is not a primary key, the execution process proceeds to step 846. At step 846, the results set data is added into the hierarchical data object for the level using the pointer, from step 834, along with column header information obtained from the query metadata table 307. The execution process then proceeds through connection point M to decision step 854.

At decision step 854, a determination is made whether all columns in a result set are covered. If all columns are not covered, the execution process 800 proceeds to step 856. At step 856, the next column of information is accessed and the execution process 800 proceeds to connection point N 857 to step 824 of FIG. 8B. Returning to decision step 854, if all columns are covered, the execution process 800 proceeds to decision step 860. At decision step 860, a determination is made whether all rows in a result set are covered. If all rows are not covered, the execution process 800 proceeds to step 862. At step 862, the next row of information is accessed and the execution process 800 proceeds to connection point P 863 to step 822 of FIG. 8B. Returning to decision step 860, if all rows are covered, the execution process 800 proceeds to decision step 866. At decision step 866, a determination is made whether all result sets are covered. If all result sets are not covered, the execution process 800 proceeds to step 868. At step 868, the next result set is accessed and the execution process 800 proceeds to connection point Q 869 to step 810 of FIG. 8A. Returning to decision step 866, if all result sets are covered, the process ends at step 870.

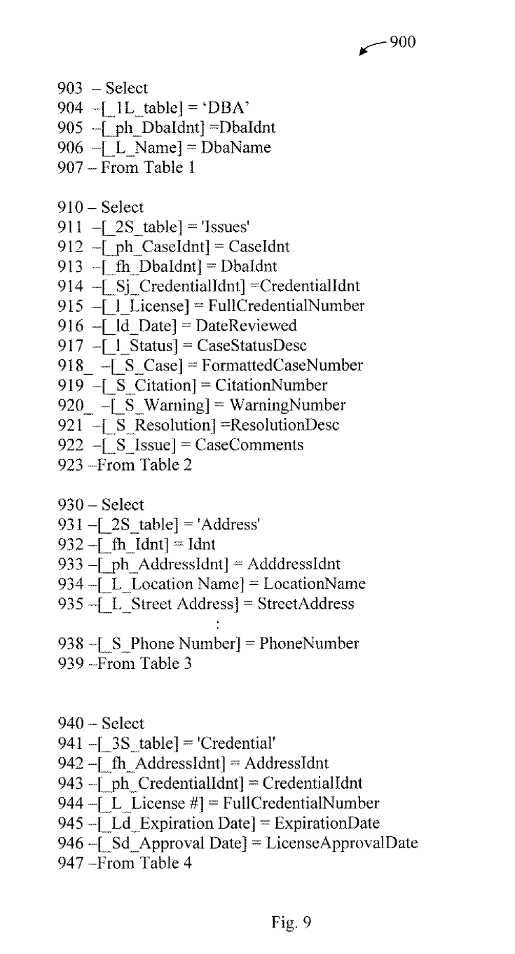

FIG. 9 illustrates exemplary tagged SQL select entries 900 for formatting multiple query result sets in a hierarchical organization in accordance with the present invention. The line entries 903-907, 910-923, 930-939, and 940-947 represent four queries that access four corresponding result sets. Each of the four queries is configured by a hierarchical level listed in the “table” entry. For example, line entry 904 uses a tag [_{—}1L_table] for the first level information of the hierarchical data object, line entry 911 uses a tag [_{—}2S_table] for the second level information, 931 uses a tag [_{—}2S_table] for additional second level information, and line entry 941 uses a tag [_{—}3S_table] for the third level information. The system ties the information from queries together using an SQL concept of primary and foreign keys. When an item of a lower hierarchical level has a foreign key value that matches a primary key value for a key of the same name, then the lower level item is a considered to be a hierarchical child of the higher level item. As used herein, level 1 is the highest level, 2 being the next, and so forth. In the example: line 905 identifies the primary key for level 1, and line 913 identifies a foreign key reference to the primary key of level 1. Thus, when an item from the second select group (lines 910-923) is read, the system will use the value of the foreign key line 913, and will search the hierarchical object to locate the entry where the primary key value matches. The primary key entry where the match is found, will be the higher level parent for the row entry of the lower level entry being processed. A similar process will be repeated for the other results sets shown in the example. Line entry 914 uses a tag [_Sj_CredentialIdnt] which uses an action tag “j” that causes the mobile database device 102 to highlight a displayed “CredentialIdnt” and to allow a user to click on the “CredentiallDnt” to jump to a “CredentialIdnt” listing display. In a similar manner, a uniform resource locator (URL) may be included as an action tag to be highlighted and if selected by a user, to jump to the web address indicated by the URL.

While the present invention has been disclosed in a presently preferred context, it will be recognized that the present teachings may be adapted to a variety of contexts consistent with this disclosure and the claims that follow. For example, the mobile database device 102 has the unique ability to support dynamic metadata tags that are applied to response data when building the hierarchical data object snippet. For ease of use and configuration, the invention allows for multiple query results columns to be merged into a single hierarchical element, with one query results column representing the data value, and the other query results columns being used for dynamic metadata tags, attributes, or other purposes. For example, a query developer determines that the mobile database system is to show a user a street address for a customer and is to have the ability to apply dynamic metadata tags that would add special characteristics to response data. Dynamic metadata tags may include, but are not limited to: display color, field title, field comments, and Internet hyperlink tags. In the following example dynamic metadata tags are added that indicate:
the display color of the street address is to be changed to green if the street is located in Miami, for example,
a hyperlink that allows the user to display the address in Google maps, and
that there are hidden comments to the street address that dynamically show upon user request.
   For example, control characters may be imbedded into a column name to identity that the column values are to be used as metadata tags and not normal display values. The name of the column less the imbedded control characters would be the column the metadata tags would be applied to, however the dynamic metadata tag, could be applied to another column by manual intervention during the query configuration process. For this example, imbedded control characters C, H, and P are used to identify specific dynamic metadata tags as follows:
C=Display Color
H=Internet Hyperlink
P=Popup Comments
   A corresponding query select statement would be built as follows for the hierarchical data object “Address” to accomplish this example:

### Select

[_{—}1_Address]=CustomerStreetAddress
[_{—}1C_Address]=CASE WHEN City=‘Miami’ THEN ‘Green’ ELSE ‘Yellow’ END
[_{—}1H_Address]=‘www.google.com/maps?’+CustomerStreetAddress+ZipCode
[_{—}1P_Address]=CustomerAddressComments
   During query execution, when building the hierarchical data object snippet, the system would recognize the imbedded control characters and add them to the snippet as metadata tags or data attributes as identified by the control characters.

Other alternatives are possible, using manual configuration techniques, for example, by the query developer to identify linked fields and their purpose as dynamic metadata tags. Another possible alternative includes, using manual configuration techniques, for example, by the query developer to identify metadata tags, other than using the imbedded tags in the SQL queries. It will be appreciated that variations in the particular hardware and software employed are feasible, and to be expected as both evolve with time. Other such modifications and adaptations to suit a particular design application and content will be readily apparent to those of ordinary skill in the art.

I claim:

1. A method for accessing information related to a request in addition to the requested information, the method comprising:
submitting a query request from a mobile user device that requests specific information from a database;
executing the query request to access a database snippet which includes the specific information and additional information related to query request;
forming a hierarchical data object from the accessed database snippet;
adding display and control tags to create a tagged hierarchical data object; and
sending the tagged hierarchical data object to the mobile user device, wherein the hierarchical data object may be accessed and displayed independently of the display size of the mobile user device.

2. The method of claim 1, further comprises:
developing the query request to access the specific information and the additional information related to the query request according to customer feedback;
determining a hierarchical structure for the specific information and the additional information; and
adding metadata tags to the query request according to the hierarchical structure, wherein the metadata tags are associated with the response to the query request.

3. The method of claim 2, further comprises:
installing the query request to a system query table; and
installing the metadata tags to a query metadata table in a configuration database.

4. The method of claim 1, further comprises:
building a listing of allowed queries that a particular user may submit; and
installing the allowed queries on the mobile user device.

5. The method of claim 1, further comprises:
filtering the query request based on user input to ensure information of a requested form is returned to the mobile user device.

6. The method of claim 1, wherein forming a hierarchical data object comprises:
adding hierarchical tags associated with specific queries, wherein a hierarchical tag indicates a level of the hierarchy that a specific query response result set belongs according to a hierarchical structure for the specific information and the additional information.

7. The method of claim 6, wherein the hierarchical tags include a primary key tag and a primary key name for an entry and a foreign key tag and foreign key name for another entry, the foreign key tag providing a reference link to the entry having the primary key name that is the same as the foreign key name.

8. The method of claim 6, wherein the hierarchical tags include an action tag for an entry, the action tag causing a display indication of an action on the mobile user device that allows a user to select the action.

9. The method of claim 6, wherein the hierarchical tags include a jump action tag that causes a jump to a primary key referenced by a foreign key to display the contents of the entry associated with the primary key.

10. The method of claim 6, wherein the hierarchical tags include a uniform resource locator (URL) tag that causes a jump to the web address indicated by the URL.

11. The method of claim 6, wherein the hierarchical tags include an input form tag that causes a jump to an input request display screen to capture requested user input.

12. A method for converting a database snippet into a hierarchical object structure having more information than requested by a user, the method comprising:
determining specific information and associated additional information related to steps a user takes to accomplish a particular activity;
submitting one or more queries to access the specific information and the associated additional information to receive response result sets corresponding to the one or more queries, wherein the response result sets represent a database snippet;
adding metadata tags to the one or more queries that identifies a hierarchical structure of the specific information and the associated additional information for display on a user device; and
tagging the corresponding response result sets, wherein the database snippet is converted to a hierarchical object structure from the tagged corresponding response result sets.

13. The method of claim 12, further comprises:
installing the hierarchical object structure on the user device; and
accessing the additional information locally on the user device in response to a user request.

14. The method of claim 12, wherein the specific information and the additional information are displayed on the user device without the need for custom display forms.

15. The method of claim 12, wherein the specific information is displayed on the user device in a row column organization with highlighted entries that a user selects to access the associated additional information according to a tag of the highlighted entry.

16. The method of claim 12, wherein the specific information and the associated additional information is displayed with highlighted entries that a user selects to enter information according to tag indicating an input request.

17. The method of claim 12, wherein the specific information and the associated additional information is displayed with highlighted entries that a user selects to jump to a web address according to a tag indicating a URL of the web address.

18. A computer-readable medium storing a computer program which causes a computer system to perform a method for accessing information related to a request in addition to the requested information, the method comprising:
submitting a query request from a mobile user device that requests specific information from a database;
executing the query request to access a database snippet which includes the specific information and additional information related to query request;
forming a hierarchical data object from the accessed database snippet;
adding display and control tags to create a tagged hierarchical data object; and
sending the tagged hierarchical data object to the mobile user device, wherein the hierarchical data object may be accessed and displayed independently of the display size of the mobile user device.

19. The computer readable medium of claim 18, further comprises:
developing a query request to access the specific information and the additional information related to the query according to customer feedback;
determining a hierarchical structure for the specific information and the additional information; and
adding metadata tags to the query according to the hierarchical structure.

20. The computer-readable medium of claim 15, wherein forming a hierarchical data object comprises:
adding hierarchical tags associated with specific queries, wherein a hierarchical tag indicates a level of the hierarchy that a specific query response result set belongs according to a hierarchical structure for the specific information and the additional information.

21. A system for accessing information related to a request in addition to the requested information, the system comprising:
a database;
a wireless mobile user device that submits a query that requests specific information from the database; and
a mobile access server operative to execute the query to access a database snippet which includes the specific information and additional information related to the query, to form a hierarchical data object from the accessed database snippet, to add display tags to create a tagged hierarchical data object, and to send the tagged hierarchical data object to the wireless mobile user device, wherein the hierarchical data object may be accessed and displayed independently of the display size of the wireless mobile user device.

22. The system of claim 21 wherein the mobile access server is further operative to build a listing of allowed queries that a particular user may submit, and install the allowed queries on the wireless mobile user device.

23. The system of claim 21, wherein the hierarchical data object includes a jump action tag that causes a jump to a primary key referenced by a foreign key to display the contents of the entry associated with the primary key.

24. The system of claim 21, wherein the hierarchical data object includes a uniform resource locator (URL) tag that causes a jump to the web address indicated by the URL.

25. The system of claim 21, wherein the hierarchical data object includes control characters imbedded into a column name to identity that column values are to be used as metadata tags and not normal display values.

26. The system of claim 21, wherein the hierarchical data object includes multiple query results columns that are merged into a single hierarchical element with one query results column representing data and another query results column used for dynamic metadata tags.

27. The system of claim 21, wherein the display tags control screen layout and functionality in displaying the specific information and additional information contained in the tagged hierarchical data object.

28. The system of claim 21, wherein metadata tags and the display tags can be imbedded in a query definition, without the need for adding the tags manually during a query configuration process.
